(19) United States
(12) Patent Application Publication
(10) Pub. No.: US 2018/0173316 A1
(43) Pub. Date: Jun. 21, 2018

(54) METHOD FOR OPERATING AN OPERATOR CONTROL DEVICE AND OPERATOR CONTROL DEVICE FOR A MOTOR VEHICLE

(71) Applicant: AUDI AG, Ingolstadt (DE)

(72) Inventors: Paul SPRICKMANN KERKERINCK, Ingolstadt (DE); Onofrio DI FRANCO, Ditzingen (DE)

(73) Assignee: AUDI AG, Ingolstadt (DE)

(21) Appl. No.: 15/574,747

(22) PCT Filed: May 19, 2016
(86) PCT No.: PCT/EP2016/061286

§ 371 Date: Nov. 16, 2017

(30) Foreign Application Priority Data
May 21, 2015 (DE) 10 2015 006 614.5

(51) Int. Cl. G06F 3/01; G06K 9/00

(52) U.S. Cl. CPC G06F 3/017; B60K 2350/903; B60K 2350/1052; G06K 9/00832

(57) ABSTRACT

An operating gesture of a user and at least one spatial position in which the operating gesture is performed are sensed without contact by a sensing apparatus of an operating device of a motor vehicle. Then a function of the motor vehicle is controlled according to the operating gesture if it was sensed that the at least one spatial position lies within a predetermined interaction space. To determine the interaction space, a predetermined determination gesture performed by the user is detected, at least one position in which the determination gesture is performed is sensed, and the at least one sensed position of the determination gesture is defined as a coordinate of the interaction space.

### CROSS REFERENCE TO RELATED APPLICATIONS

This application is the U.S. national stage of International Application No. PCT/EP2016/061286, filed May 19, 2016 and claims the benefit thereof. The International Application claims the benefit of German Application No. 10 2015 006 614.5 filed on May 21, 2015, both applications are incorporated by reference herein in their entirety.

### BACKGROUND

Described below is a method for operating an operator control device of a motor vehicle, in which an operator control gesture of a user and at least one spatial location at which the operator control gesture is carried out are sensed in a contactless fashion by a sensing apparatus of the operator control device, and in reaction thereto a function of the motor vehicle is controlled in dependence on the operator control gesture if it has been sensed that the at least one spatial location lies within a predetermined interaction space. Also described is an operator control device of a motor vehicle that can be operated according to the method.

Operator control devices are known in a variety of ways from the related art. Such operator control devices can, as described for example in DE 10 2011 102 038 A1, be used to control a home automation system. Operator control devices can also be provided in motor vehicles in order to be able to control, for example, an infotainment system or other functions of the motor vehicle. The fact that such operator control devices can also be operated by operator control gestures, carried out by a person, for example, with their hands, in order to control the functions is also already known from the related art. A method for detecting operator control gestures is disclosed here, for example, in DE 102 33 233 A1. Furthermore, US 2015/0025740 A1 shows that a gesture control system can be activated to control functions of a motor vehicle by sensing an operator control gesture within a valid sensing range.

This valid sensing range is usually a predetermined interaction space within which the operator control gestures for controlling the functions are to be carried out in order to prevent, for example, the functions being controlled inadvertently or undesirably. In this context it may be the case that this predetermined interaction space is not suitable to the same extent for every vehicle occupant or every user, since the predetermined interaction space lies outside the range of a user owing, for example, to the current sitting position of the user.

### SUMMARY

Described below is a solution as to how functions of a motor vehicle can be controlled in a user-specific and at the same time particularly reliable fashion by an operator control device.

Described below are a method for operating an operator control device and an operator control device. Advantageous embodiments are in the description below and illustrated in the figures.

The method described herein serves to operate an operator control device of a motor vehicle by which functions of the motor vehicle can be controlled. In the method, an operator control gesture of a user and at least one spatial location at which the operator control gesture is carried out are sensed in a contactless fashion by a sensing apparatus of the operator control device, and in reaction thereto a function of the motor vehicle is controlled in dependence on the operator control gesture if it has been sensed that the at least one spatial location lies within a predetermined interaction space. Furthermore, in order to determine the interaction space, a predetermined determining gesture, which has been carried out by the user, is detected, at least one location at which the determining gesture is carried out is sensed, and the at least one sensed location of the determining gesture is defined as a coordinate of the interaction space.

Using the operator control device, it is possible to control, for example, an infotainment system, for example functions of a tablet, of the motor vehicle, but also other functions, for example functions of a window lifter or of a lighting device of the motor vehicle, by operator control gestures of the user. The operator control device has for this purpose the sensing apparatus which is arranged, in particular, in a passenger compartment or a passenger cell of the motor vehicle and senses the operator control gesture of the user, who is located in the passenger cell, by a suitable sensor system. Such a sensing apparatus can be, for example a 2D or 3D camera. However, a functional control operation or functional triggering is brought about by the operator control gesture of the user which is sensed by the sensing apparatus only if the operator control gesture is carried out by the user within the predetermined interaction space or operator control space, that is to say if it has been sensed by the sensing apparatus that the at least one sensed location of the operator control gesture lies within the interaction space.

The method includes a provision that the interaction space can be defined or determined by the user himself. For this purpose, the user carries out the predetermined determining gesture which is sensed and detected by the sensing apparatus. In this context, the at least one coordinate of the interaction space is defined, for example by a control device, as that location at which the user carries out the determining gesture. This means that in a common coordinate system, for example in the passenger compartment of the motor vehicle, the at least one coordinate of the interaction space and the at least one position of the determining gesture are identical. In other words, the user can determine the location of his personal interaction space himself by the location of the determining gesture carried out by him. The interaction space can be stored, for example, in a storage apparatus of the operator control device. During subsequent operator control gestures of the user which are sensed by the sensing apparatus it is then possible, for example, for the control apparatus of the operator control device to check whether the operator control gestures are carried out within the interaction space which is defined by the user.

It is therefore advantageously possible for the user or the vehicle occupant to define, for example as a function of his current sitting position in the passenger compartment of the motor vehicle, an interaction space which is suitable for him and as a result control functions of the motor vehicle easily and reliably.

The interaction space determining process may be activated as soon as a predetermined activation position of two hands of the user is detected. A predetermined relative movement of the hands from the activation position into an end position of the hands is sensed as the determining gesture, and the locations of the hands during the execution of the relative movement is sensed as the at least one location. In this context, the locations of the hands in the end position are defined as coordinates of outer boundaries of the interaction space. In order to initiate or activate the interaction space determining process, the user therefore moves his hands into the predetermined activation position which is detected as such by the sensing apparatus. Starting from this activation position, the user moves his hands relative to one another in accordance with the predetermined relative movement. The user carries out the predetermined relative movement until his hands assume the end position which can be determined by the user himself. In this context, the locations of the hands during the execution of the relative movement in particular the end locations of the hands in the end position, are sensed by the sensing apparatus. The outer boundaries of the interaction space are placed at the end locations. The user can therefore advantageously define not only a location of the interaction space but also a size or a spatial extent of the interaction space depending on where the user positions his hands in the end position.

According to one embodiment, movement apart of the hands along a first spatial direction from the activation position, in which the hands are at a first distance from one another, into the end position, in which the hands are at a second distance which is larger compared to the first distance, is sensed as the predetermined relative movement. A first spatial extent, limited by the location of the hands in the end position, of the interaction space includes the second distance here. As a result of moving their hands apart, the user therefore spans an area between his hands and determines the first spatial extent of the interaction space in the first spatial direction by the end locations of his hands. Such a relative movement which is predetermined in order to define the interaction space can therefore be carried out particularly intuitively and therefore easily by the user. As a result of the user moving his hands apart, which can be perceived visually and haptically by the user, the user is made clearly aware here of a position and of dimensions of the interaction space.

The second distance may be defined for a second spatial extent of the interaction space in a second spatial direction oriented perpendicularly with respect to the first spatial direction, and the second distance is defined for a third spatial extent of the interaction space in a third spatial direction oriented perpendicularly with respect to the first and second spatial directions. The spatial extents in all three spatial directions are therefore set, for example by the control apparatus, to the second distance which has been sensed by the sensing apparatus. In other words, this means that the user moves his hands apart along the first spatial direction as far as the second distance and therefore determines not only the spatial extent in the first spatial direction but also the spatial extents in the second and third spatial directions. The user can therefore define the spatial dimensions of the entire interaction space by a single relative movement of his hands. If the user moves his hands apart, for example in a horizontal spatial direction as the first spatial direction, he therefore determines a value of a width of the interaction space. At the same time, as a result a height and a depth of the interaction space are also defined and set, for example by the control device, to the value of the width. In other words, this means that the user draws a cube with his hands, for example, wherein the locations of the hands in the activation position lie within the cube, in particular in the region of the center point of the cube. The definition of the interaction space is therefore made particularly easy for the user.

According to one embodiment, contact between surfaces of the hands is detected as the activation position. In order to define the interaction space, the user can move apart the surfaces of his hands which are in contact, for example, in the horizontal spatial direction as the first spatial direction. Alternatively or additionally, contact between at least two fingers of the one hand with at least two fingers of the other hand is detected as the activation position. For this purpose, the user can touch, for example with the index finger of one hand, the thumb of the other hand, and with the thumb of the one hand the index finger of the other hand. In other words, the user forms a frame with his index fingers and his thumbs, wherein in order to define the interaction space he can move his hands apart in a diagonal direction as the first spatial direction. Therefore, for example the control apparatus determines the spatial extent of the interaction space and the coordinates thereof by the length of the diagonals and the locations of the hands in the end position. Such activation positions are, on the one hand, particularly easy to carry out for the user and, on the other hand, generally do not correspond to any random movement which is carried out by the user. An intention of the user to determine the interaction space can therefore be detected particularly reliably by the operator control device.

One advantageous embodiment provides that the determining gesture which is to be carried out in order to define the interaction space is displayed figuratively to the user on a display apparatus of the operator control device. In other words, the user is therefore provided with guidance as to how he can define his personal interaction space. For this purpose, for example a film sequence which shows a person or only the hands of a person during the execution of the determining gesture can be displayed on the display apparatus which can be arranged in the form of a screen in the passenger compartment of the motor vehicle. The display apparatus can permit the user to carry out a particularly customer-friendly interaction space determining process.

There can also be provision that visual feedback on whether the interaction space determining process has functioned, that is to say whether the sensing apparatus has detected the predetermined determining gesture and correctly defined the interaction space or whether the process has to be repeated, is provided to the user on the display apparatus. A signal as to whether, during the execution of the operator control gestures for controlling the functions of the motor vehicle, the user's hands are located within the interaction space which is defined by the user can also be output to him on the display device or by some other signal output device of the motor vehicle.

In one refinement, a tolerance range which directly adjoins the interaction space is defined, and the function is thus controlled if the operator control gesture is carried out within the interaction space and/or within the tolerance range. This is particularly advantageous since the user can then operate functions of the motor vehicle by the operator control device even when he is no longer aware of the precise size of the interaction space defined by him, or the precise position of the interaction space, and therefore inadvertently almost carries out his operator control gestures outside the interaction space.

During the sensing of a further determining gesture, a new interaction space may be determined. In this context, the function of the motor vehicle is controlled only if the operator control gesture is carried out in the new interaction space. This means that an interaction space which has been previously carried out by the user can be overwritten by carrying out a new determining gesture. This is particularly advantageous if the user has, for example, changed his sitting location and the position and/or dimensions of the interaction space previously determined for the user are no longer suitable in the new sitting location. The user can therefore define, for example, for each sitting location, that interaction space in which he can comfortably act and control functions of the motor vehicle.

There can also be provision that in order to make available a personalized interaction space, in addition to the determining gesture the user carrying out the determining gesture is sensed, and the personalized interaction space which is determined by each user is stored for each user for the purpose of controlling the functions. A separate interaction space can therefore be sensed for each user of the motor vehicle and stored, for example, on a storage apparatus of the operator control device. The personalized interaction space can then be made available for the corresponding user who has been detected by the sensing apparatus.

Also described herein is an operator control device for a motor vehicle for controlling a function of the motor vehicle having a sensing apparatus for sensing an operator control gesture of a user and having at least one spatial location of the operator control gesture and one control apparatus for controlling the function as a function of the operator control gesture which is carried out, wherein the control apparatus is configured to control the function only if the at least one location which is sensed by the sensing apparatus lies within a predetermined interaction space. Furthermore, the sensing apparatus is configured to detect a predetermined determining gesture, carried out by the user, for determining the interaction space and to sense at least one location at which the determining gesture is carried out. The control apparatus is configured to define the at least one sensed location of the determining gesture as a coordinate of the interaction space.

The embodiments presented with respect to the method and the advantages thereof apply correspondingly to the operator control device.

### BRIEF DESCRIPTION OF THE DRAWINGS

of the exemplary embodiments, taken in conjunction with the accompanying drawings of which:

These and other aspects and advantages will become more apparent and more readily appreciated from the description below on the basis of an exemplary embodiment and also with reference to the appended drawings of which:

FIG. 1 is a schematic side view of a motor vehicle with an embodiment of an operator control device;

FIG. 2a is a schematic perspective view of an activation position of two hands during a determining gesture; and

FIG. 2b is a schematic perspective view of an end position of two hands during a determining gesture.

### DETAILED DESCRIPTION OF THE PREFERRED EMBODIMENT

In the figures, identical and functionally identical elements are provided with the same reference symbols.

In the exemplary embodiment, the described components of the embodiment each constitute individual features which are to be considered independently of one another and which each also develop the invention independently of one another and at the same time are also to be a component, either individually or in another combination than that shown. Furthermore, further features which have already been described can also be added to the described embodiment.

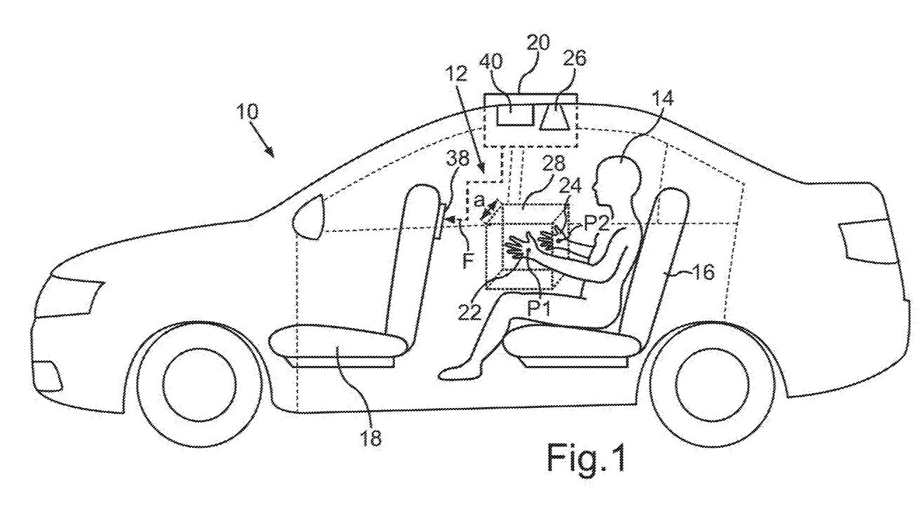

FIG. 1 shows a motor vehicle 10 having an operator control device 20 by of which a user 14 can control a function F of the motor vehicle 10. The user 14 is illustrated sitting here in a passenger compartment 12 of the motor vehicle 10 on a rear seat 16 of the motor vehicle 10, in particular in a comfortable, reclined sitting position. The function F which is to be controlled is here a function of a display apparatus 38, for example in the form of a tablet or a touch-sensitive screen which is arranged on a backrest of a front seat 18 of the motor vehicle 10 and lies, in particular, outside a range of the user 14. In other words, the user 14 cannot control the function F of the touch-sensitive screen by touching the touch-sensitive screen. However, the user 14 can control the function F of the motor vehicle 10 in a contactless fashion by operator control gestures which the user 14 carries out with his hands 22, 24. In order to sense the operator control gestures of the user 14 and to sense at least one location of the hands 22, 24 of the user 14, the operator control device 20 has a sensing apparatus 26, for example in the form of a so-called time-of-flight camera. In order to avoid undesired incorrect triggering or incorrect control of the function F, a control apparatus 40 of the operator control device 20 is configured to control the function F only when it has been sensed by the sensing apparatus 26 that the operator control gestures of the user 14 have been carried out within a predetermined interaction space 28.

There is provision here that the user 14 can himself define or determine the interaction space 28, in particular a position and dimensions of the interaction space 28 within the passenger compartment 12 of the motor vehicle 10. In this way, the user 14 can determine the interaction space 28, for example as a function of his sitting position, in such a way that operator control gestures for controlling the function F can be carried out easily and comfortably within the interaction space 28. For this purpose, the user 14 carries out a predetermined determining gesture with his hands 22, 24, which gesture is sensed by the sensing apparatus 26 and detected as such. In addition, at least one location of the determining gesture or at least one location of the hands 22, 24 of the user 14 is sensed during the execution of the determining gesture and defined as a coordinate of the interaction space 28, for example by the control apparatus 40 of the operator control device 20.

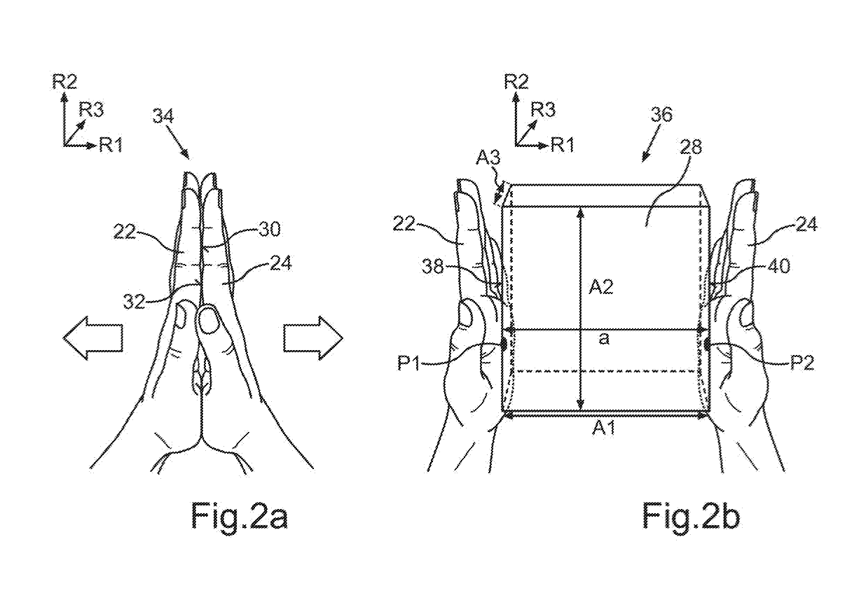

In order to initialize the determination of the interaction space 28, the sensing apparatus 26 detects a predetermined activation position 34 of the hands 22, 24 of the user 14. One embodiment of the predetermined activation position 34 is depicted by of the hands 22, 24 illustrated in FIG. 2a. Such an activation position 34 can be assumed, for example, by contact of surfaces 30, 32 of the hands 22, 24 of the user 14. From this activation position 34, the user 14 then moves his hands 22, 24 in accordance with the predetermined relative movement. Movement apart of the hands 22, 24 in a first spatial direction R1, for example in a horizontal spatial direction, can be detected as such a predetermined relative movement by the sensing apparatus 26. The relative movement of the hands 22, 24 is therefore carried out up to an end position 36 of the hands 22, 24. One embodiment of an end position 36 of the hands 22, 24 is shown on the basis of the hands 22, 24 illustrated in FIG. 2b.

In the end position 36 according to FIG. 2b, the hands 22, 24 are at a distance a from one another, which distance a can be freely determined by the user 14. A first spatial extent A1 of the interaction space 28 in the first spatial direction R1 is determined by this distance a. Furthermore, it can be provided that a second spatial extent A2 is defined in a second spatial direction R2 oriented perpendicularly with respect to the first spatial direction R1 and a third spatial extent A3 can be defined in a third spatial direction R3 which is oriented perpendicularly with respect to the first spatial direction R1 and perpendicularly with respect to the second spatial direction R2, also with the distance a, for example from the control apparatus 40. By of the movement apart of the hands 22, 24, a virtual cube is therefore drawn which is determined as a user-specific interaction space 28, for example by the control apparatus 40, and stored, for example in a storage apparatus (not illustrated) of the operator control device 20.

Furthermore, the sensing apparatus 26 senses locations which the hands 22, 24 assume during the execution of the relative movements. In FIG. 2b, for example the end locations P1, P2 of the hands 22, 24 are shown, wherein the hand 22 assumes the location P1 in the end position of the hands 22, 24, and the hand 24 assumes the location P2 in the end position of the hands 22, 24. The locations P1, P2 are defined here as coordinates of an outer boundary of the interaction space 28. In a fixed coordinate system in the passenger compartment 12 of the motor vehicle 10, locations P1, P2 of the hands 22, 24 are identical to the coordinates of the outer boundary of the interaction space 28.

In addition there can be provision that the determining gesture for determining the interaction space 28 is displayed, for example in a film sequence, to the user 14 on the display apparatus 38 of the operator control device 20, for example the tablet which is arranged in the backrest of the front seat 18. The user 14 is therefore provided with visual guidance as to how he can define his personal interaction space 28.

By the determining gesture the user 14 can therefore determine both the position of the interaction space 28 in the passenger compartment 12 of the motor vehicle 10 and the dimension of the interaction space 28, that is to say the spatial extents A1, A2, A3. Furthermore, for example the control apparatus 40 can define a tolerance range which adjoins the interaction space 28, wherein the control apparatus 40 controls the function F even if it has been sensed by the sensing apparatus 26 that the user 14 is carrying out the operator control gesture for controlling the function F, for example, outside the interaction space 28 but within the adjoining tolerance range.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for operating an operator control device of a motor vehicle, comprising:
sensing an operator control gesture of a user and at least one spatial location at which the operator control gesture is carried out in a contactless fashion by a sensing apparatus of the operator control device;
controlling, in reaction to said sensing of the operator control gesture, a function of the motor vehicle in dependence on the operator control gesture when the at least one spatial location lies within an interaction space; and
determining the interaction space, prior to said sensing of the operator control gesture, by detecting a predetermined determining gesture carried out by the user in at least one location defined as a coordinate of the interaction space, including
activating the interaction space determining as soon as a predetermined activation position of hands of the user is detected,
sensing a predetermined relative movement of the hands from the predetermined activation position into an end position of the hands as the predetermined determining gesture,
defining locations of the hands during the predetermined relative movement as the at least one location, including the locations of the hands in the end position as coordinates of outer boundaries of the interaction space,
sensing, as the predetermined relative movement, movement apart of the hands along a first spatial direction from the predetermined activation position, in which the hands are separated by a first distance, into the end position, in which the hands are separated by a second distance larger than the first distance, and
defining a first spatial extent of the interaction space as the second distance.

12. The method as claimed in claim 11, wherein the second distance defines a second spatial extent of the interaction space in a second spatial direction oriented perpendicularly with respect to the first spatial direction, and the second distance defines a third spatial extent of the interaction space in a third spatial direction oriented perpendicularly with respect to the first and second spatial directions.

13. The method as claimed in claim 12, wherein contact between surfaces of the hands and/or contact between at least two fingers of a first hand and at least two fingers of a second hand is detected as the predetermined activation position.

14. The method as claimed in claim 11, wherein contact between surfaces of the hands and/or contact between at least two fingers of a first hand and at least two fingers of a second hand 24) is detected as the predetermined activation position.

15. The method as claimed in claim 11, further comprising displaying the predetermined determining gesture figuratively to the user on a display apparatus of the operator control device.

16. The method as claimed in claim 11,
further comprising defining a tolerance range directly adjoining the interaction space, and
wherein said controlling controls the function of the motor vehicle when the operator control gesture is carried out within at least one of the interaction space and the tolerance range.

17. The method as claimed in claim 11,
further comprising determining, when a further determining gesture is sensed, a new interaction space, and
wherein said controlling controls the function of the motor vehicle subsequent to determining the new interaction space only when the operator control gesture is carried out in the new interaction space.

18. The method as claimed in claim 11,
further comprising:
identifying the user to make available a personalized interaction space, by sensing the user carrying out the predetermined determining gesture, and
storing the personalized interaction space determined for each user, and
wherein said controlling the function of the motor vehicle is performed based on the operator control gesture sensed in the personalized interaction space of the user.

19. An operator control device of a motor vehicle for controlling a function of the motor vehicle, comprising:
a sensing apparatus configured to sense an operator control gesture of a user in at least one spatial location; and
a control apparatus configured
to control the function of the motor vehicle based on the operator control gesture only when the at least one spatial location sensed by the sensing apparatus lies within an interaction space,
to detect a predetermined determining gesture, carried out by the user, determining the interaction space,
to sense at least one location at which the predetermined determining gesture is carried out,
to define the at least one location of the predetermined determining gesture as a coordinate of the interaction space,
to activate the determining of the interaction space as soon as a predetermined activation position of hands of the user is detected by the sensing apparatus,
to sense a predetermined relative movement of the hands from the predetermined activation position into an end position of the hands as the predetermined determining gesture, and
to define locations of the hands during the predetermined relative movement as the at least one location, including the locations of the hands in the end position as coordinates of outer boundaries of the interaction space,
the sensing apparatus being configured to sense, as the predetermined relative movement, movement apart of the hands in a first spatial direction from the predetermined activation position, in which the hands are separated by a first distance, into the end position in which the hands are separated by a second distance larger than the first distance and defining a first spatial extent of the interaction space, bounded by the locations of the hands in the end position.

20. The operator control device as claimed in claim 19, wherein the second distance defines a second spatial extent of the interaction space in a second spatial direction oriented perpendicularly with respect to the first spatial direction, and the second distance defines a third spatial extent of the interaction space in a third spatial direction oriented perpendicularly with respect to the first and second spatial directions.

21. The operator control device as claimed in claim 20, wherein contact between surfaces of the hands and/or contact between at least two fingers of a first hand and at least two fingers of a second hand is detected as the predetermined activation position.

22. The operator control device as claimed in claim 19, wherein contact between surfaces of the hands and/or contact between at least two fingers of a first hand and at least two fingers of a second hand 24) is detected as the predetermined activation position.

23. The operator control device as claimed in claim 19, further comprising a display device configured to display the predetermined determining gesture figuratively to the user.

24. The operator control device as claimed in claim 19, wherein the control apparatus is further configured
to define a tolerance range directly adjoining the interaction space, and
to control the function of the motor vehicle when the operator control gesture is carried out within at least one of the interaction space and the tolerance range.

25. The operator control device as claimed in claim 19, wherein the control apparatus is further configured
to determine, when a further determining gesture is sensed, a new interaction space, and
to control the function of the motor vehicle subsequent to determining the new interaction space only when the operator control gesture is carried out in the new interaction space.

26. The operator control device as claimed in claim 19,
wherein the sensing apparatus is further configured to sense the user carrying out the predetermined determining gesture, and
wherein the control apparatus is further configured to store a personalized interaction space associated with each user and to control the function of the motor vehicle based on the operator control gesture sensed in the personalized interaction space of the user.
